(19) United States
(12) Patent Application Publication
(10) Pub. No.: US 2018/0186473 A1
(43) Pub. Date: Jul. 5, 2018

(54) DRONE HOTEL AND SYSTEM, METHOD AND COMPUTER PROGRAM PRODUCT FOR A DRONE HOTEL

(71) Applicant: International Business Machines Corporation, Armonk, NY (US)

(72) Inventors: Thomas D. Erickson, Minneapolis, MN (US); Clifford A. Pickover, Yorktown Heights, NY (US); Maja Vukovic, New York, NY (US); Komminist Weldemariam, Nairobi (KE)

(73) Assignee: International Business Machines Corporation

(21) Appl. No.: 15/396,927

(22) Filed: Jan. 3, 2017

(51) Int. Cl. B64F 1/00; G06Q 30/08; G06Q 30/06; B60L 11/18

(52) U.S. Cl. CPC B64F 1/00; G06Q 30/08; B60L 2200/10; B60L 11/1825; G06Q 30/0645

(57) ABSTRACT

A drone hotel including a plurality of compartments arranged in a docking array for selectively docking at least one drone in a compartment and a connector disposed in each compartment for providing a connection to the docked drone of the compartment, a location of the plurality of compartments in the docking array is based on a function provided in the compartment and a drone hotel control method, system, and computer program product for the same.

### BACKGROUND

The present invention relates generally to a drone hotel and drone hotel control method, and more particularly, but not by way of limitation, to a system, method, and computer program product for controlling docking compartments in the drone hotel.

Drones are increasingly becoming a larger part of the market and their uses being expanded into the private sector. As a result of the expansion, there is a growing need for service, storage, and security for drones in active areas.

### SUMMARY

In an exemplary embodiment, the present invention can provide a drone hotel, including a plurality of compartments arranged in a docking array for selectively docking at least one drone in a compartment and a connector disposed in each compartment for providing a connection to the docked drone of the compartment, where a location of the plurality of compartments in the docking array is based on a function provided in the compartment.

In an exemplary embodiment, the present invention can provide a computer-implemented drone hotel control method for a drone hotel having a plurality of compartments arranged in a docking array for selectively docking at least one drone in a compartment, the method including docking a drone in a compartment in the drone hotel, providing an electrical connection or a communication connection between the compartment in the drone hotel and the docked drone via a connector, and creating a secondary market between a plurality of drones docked in the drone hotel via an interface displaying each drone connected to the connector of the compartment.

One or more other exemplary embodiments include a computer program product and a system.

Other details and embodiments of the invention will be described below, so that the present contribution to the art can be better appreciated. Nonetheless, the invention is not limited in its application to such details, phraseology, terminology, illustrations and/or arrangements set forth in the description or shown in the drawings. Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIG. 1 exemplarily shows a high-level flow chart for a drone hotel control method 100;

FIG. 2 exemplarily shows a drone hotel 200 including a plurality of compartments 200a-200g;

FIG. 3 exemplarily shows a drone hotel installed on a pole 301;

FIG. 4 depicts a cloud computing node 10 according to an embodiment of the present invention;

FIG. 5 depicts a cloud computing environment 50 according to an embodiment of the present invention; and

FIG. 6 depicts abstraction model layers according to an embodiment of the present invention.

### DETAILED DESCRIPTION

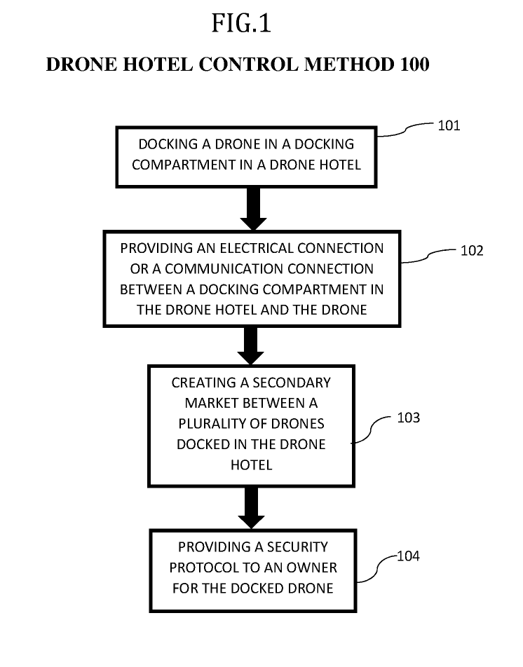

The invention will now be described with reference to FIGS. 1-6, in which like reference numerals refer to like parts throughout. It is emphasized that, according to common practice, the various features of the drawing are not necessarily to scale. On the contrary, the dimensions of the various features can be arbitrarily expanded or reduced for clarity.

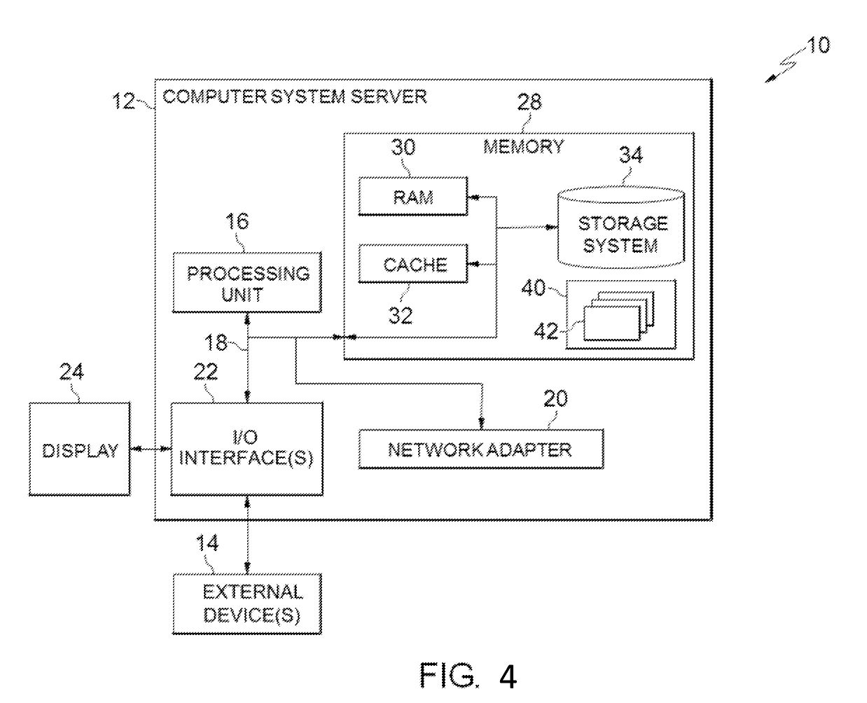

With reference now to the example depicted in FIG. 1, the drone hotel control method 100 includes various steps to provide electrical or information communication to drones based on location in an enclosure of a drone hotel (i.e., container or housing) while creating a secondary market between the drones in the drone hotel. As shown in at least FIG. 4, one or more computers of a computer system 12 according to an embodiment of the present invention can include a memory 28 having instructions stored in a storage system to perform the steps of FIG. 1.

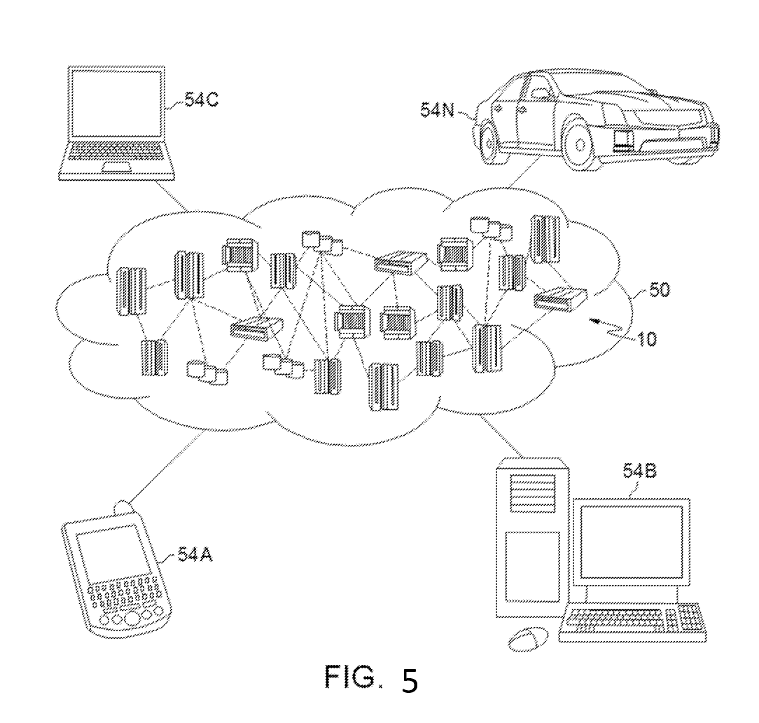

Although one or more embodiments (see e.g., FIGS. 4-6) may be implemented in a cloud environment 50 (see e.g., FIG. 5), it is nonetheless understood that the present invention can be implemented outside of the cloud environment.

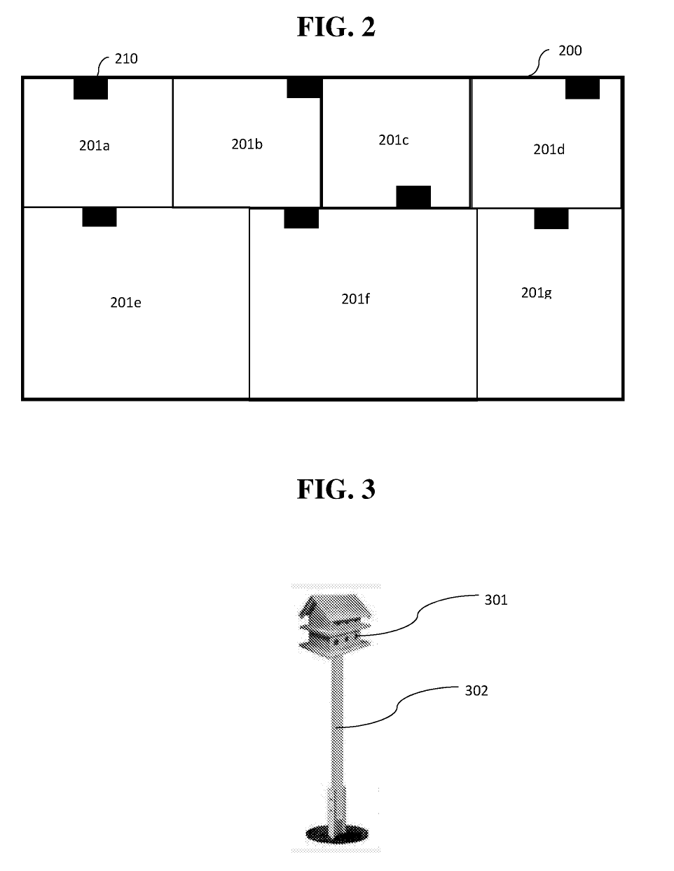

Referring now to FIG. 2, FIG. 2 exemplarily depicts a drone hotel 200. The drone hotel 200 includes a plurality of compartments 100a-100g in a docking array. The drone hotel 200 may be located on poles, sides of buildings, cell phone towers, light poles, telephone poles, stationary or moving tracks (e.g. drone swarms can cooperate with delivery trucks while uploading and offloading tasks), trains, etc. The drone hotel 200 located on moving tracks, buses or trains may be used as an energy saving strategy for drones depending on the direction of the moving tracks. The drone hotel 200 may provide automated storage on retractable pallets.

Although the drone hotel 200 is configured in a rectangle in FIG. 2, the invention is not limited to rectangular compartments. That is, the compartments of the drone hotel and the drone hotel itself can be of any polygonal, circular, elliptical, etc. shape capable of housing the drones.

Each of the compartments 200a-200g in the docking array of the drone hotel 200 can different sizes, shapes, and provide different functions/services (e.g., via a connector 210 between the drone and each compartment) for the drones parked in the compartment. The connector 210 in each compartment can connect with the drone (either physically or through a network connection such as WiFi or BlueTooth). The connector 210 can connect with the drone to recharge a battery, provide software updates for drone components, download drone video and surveillance data, etc. For example, the connector 210 may facilitate battery charging or changing. For example, a first battery bay could be located in the enclosure, and a battery replacement assembly may be used to remove a battery from the drone and to replace the battery with a new battery. A power source may provide power to the drone while the drone is positioned on the platform.

In some embodiments, the connector 210 can provide stocks of payload materials such as fertilizers, pesticides, vaccines, etc. to the drone that support tasks that drones working in the region may be likely to need. That is, the drone can dock in the drone hotel 200 and then the connector 210 can be used to provide needed materials to the drone for the drones mission.

Further, the connectors 210 in the compartments are connected to each other to allow communication between drones of different compartments in the drone hotel 200. For example, if a drone swarm docks in the drone hotel 200, it is possible that the drones may be able to distinguish a companion drone (e.g., another drone in the drone swarm) from other drones in the area or in the hotel, and dock near one another, when space permits. Some of the drones may be in the hotel (e.g., as part of the swarms or as independent agents) and may serve as protector drones for others in the hive or hotel. The hotel security drones may provide surveillance and other protective features.

In some embodiments, locations of the compartments 200a-200g in the docking array can be based on the function of the compartment. Thus, the drone hotel 200 may have regions therein for different drones, different functions for drones, etc. For example, compartments 201d and 201g can be refrigerated (heated) compartments for drones carrying perishable materials while the walls between 201d/g and 201c/f can be insulated and 201c and 201f can be room temperature for general storage of the drone. Either individual compartments, or other compartments in the drone hotel 200, may be used to provide controlled environments for material work products of drone activities, such as environmental or biological samples gathered during the course of an assay.

In some embodiments, the location dependence in the array may be related to bandwidth (e.g. compartments in the array in the top row may have a higher bandwidth than those in the bottom row), electrical characteristics, door characteristics, charging via solar power, etc. For example, compartments 201a-201d can include reinforced doors with special lock-pads to open (e.g., high security), whereas compartments 201e, 201f, and 201g can include easy access doors (e.g., low security) for drones that do not require any special security needs or include a sensitive payload. Doors on the compartments may open and close based on criteria and controls such as security, flight navigation (e.g., based on the flight path of the drone), etc.

For mission-critical drones such as government drones, secure communication challenge is key and in the situation where drones face interment connectivity (e.g. not having enough bandwidth to transmit critical video streams), the connector 210 may provide temporary high “secure” internet connection. Some compartment(s) in the drone hotel may be equipped to host only the mission-critical drones.

Some drone owners may need to secure the drones while they are inaccessible by the drone owner. The compartments 201a-201g may allow for owners to store drones while owners are away and may include possible maintenance activities.

Also, drones of similar purpose (e.g. delivery, lighting, security, etc.) may be placed next to each other to encourage peer-to-peer drone software updates. That is, the compartments 201a-201g can be set based on the intended type of drone to be docked in the compartment. Drones whose owners may have a “conflict of interest” may be placed far from each other. Social networking techniques can be employed to learn more about owners, their preferences and properties, and classify their drones accordingly. On the other hand, drone placement may be used to stimulate serendipitous meetings amongst the owners based on their profile and interests.

It is noted that the connector 210 can act as a “kiosk”. That is, a kiosk as part of the connector can be provided in compartments, each large enough to receive a respective unmanned aerial device and accessible to one or more users. In some embodiments, the kiosk of the compartments on a pole may also include one or more beacons configured to emit an optical or other wireless homing signal recognizable to one or more drones. Each of the bays may have protruding or recessed electrical or communication contacts to permit each drone to recharge after it lands within the compartment.

In some embodiments, as shown in FIG. 3, if the drone hotel is installed on a pole 302, the pole 302 may rotate to provide optimal positioning for drones with respect to wind, sunshine, rain, snow, etc. (e.g., an outside event). That is, the drone hotel may be installed on the pole 302 to have multiple compartments 301 for the drones. The pole 302 may rotate to allow the compartments 301 to be at different positions.

In the drone hotel 200, drone owners may rent space on a short-term basis (month-to-month, though options for longer-term leases are available) to other drone owners or companies. The location of the compartments 200a-200g providing different features can be arranged according to a price of the rental or price of the usage. Drones may or may not be generally covered by the hotel's insurance. The lessor may be covered by his/her own insurance policy or may purchase insurance to cover the drones. The rented drone spaces in the hotel may optionally be secured by the drone (or drown owner's) electronic lock and key.

It is noted that the location of the compartments in the drone hotel 200 and the interaction of drone owners creates a secondary market that includes any of trading, bartering, renting, auctioning, exchanging information, etc. For example, a police force drone can be docked in one compartment attempting to analyze crime scene aerial photos. The police force drone is missing aerial shots of a particular street. The police force drone can send a request for information from other drones in the drone hotel 200 for aerial photos of the street. In a second example, a first company may have a fleet of delivery type drones (e.g., for delivering packages), whereas a second company may have a single drone that is capable of high-speed navigation. The first company can license use of the second company's drone for “rush” deliveries (e.g., bartering).

That is, the secondary market is created because besides the drone hotels 200 serving as a waystation for drones in transit, hotels may function as temporary bases for operations in a particular locale. A consequence of this is that hotels provide services that enable its guests to operate in the locale, and also that as the hotel monitors the services it is providing to its occupants, it is better able to evaluate the value of those services and provide better recommendations to its occupants. In the case of a drone hotel, the services might include offering local maps of highly dynamic features (e.g., turbulence, risk of vandalism, or pedestrian density). Such information might be gathered by offering discounts to its visitors for access to their sensor records, or it might facilitate trading of information among occupants. Drone hotels might also offer physical services, such as storage (e.g., a controlled environment in which drone-collected samples may be securely stored), or the rental of accessories (e.g., a high-resolution camera). Thus, the hotel can provide a forum that lets the owners or the pilots of its drone engage in social interaction or information exchange

Because hotels provide their services for a fee, they depend on various means to attract occupants including siting themselves in a heavily trafficked area, and various means of advertising. In the case of a drone hotel, this might include beacons, to allow drones to home-in on the hotel, and the ability to mount drone hotels in promising areas (e.g., on the sides of buildings, attached to a pole, attached to a cruise ship, etc.).

The drone hotel can provide enclosures with doors that can be secured by various mechanisms (locks), and other services that support privacy (e.g., a communications firewall, a faraday cage, etc.) and security (e.g., surveillance cameras or guard drones equipped with defense mechanisms). For example, if a user wishes to protect the wireless features of the drone from surrounding wireless signals while in the hotel, a very effective way to do this is to secure the compartment itself by making it act as a Faraday cage (e.g., the compartment includes a function of a Faraday cage), shielding the radio frequency waves used by Wi-Fi. Here, one or more compartments function as Faraday cages by encasing them a thin layer of conductive material or metal mesh.

To maintain the privacy and security, a drone hotel may implement a block-chain infrastructure. For reducing the owner's stress, drone hotels may maintain a public ledger (e.g., a block chain infrastructure) such that drone owners can transparently access or query the status and state of their drones. Owners may sign contractual agreement with drone hotels through block chain to checkout maintenance, parking, and other services (software update, data exchange, markets, directory, etc.) fees.

Because occupants of the drone hotel 200 are frequently in transit, hotels provide services that are geared towards those who are mobile. In the case of the drone hotel 200, these include recharging (via en-suite docks or battery swapping systems), maintenance (via automatic software upgrades; robotic-or human-assisted hardware upgrades), and provisioning (e.g., providing drones with payloads like fertilizer or pesticides or vaccines).

In some embodiments, the ability to provide temporary access to secure physical enclosures for drones facilitates the rental or sharing of the drones housed in the hotel. In another embodiment, drones housed in the hotel that are between jobs (e.g., between flight missions) can lease out on-board capabilities such as computational power, or swap their own full batteries for another drone's emptied ones. In some embodiments, rather than functioning as a “hotel” with a single owner, the ‘drone hotel’ might provide a secondary market (like a condominium or timeshare complex) where individuals own and sublet their own enclosures, with their own array of amenities.

Referring to FIG. 1 and the drone hotel control method 100, in step 101, a drone is docked in a docking compartment 200a-200g in the drone hotel 200. That is, the requirements of the drone can be sent to the drone hotel 200 in advance such that the method 100 can determine what requirements/services the drone needs while docked and where to dock the drone in the drone hotel based on the needed requirements/services. For example, the drone can require a battery change, a refrigerated compartment, or a high-speed internet connection.

In step 102, an electrical connection or a communication connection between the docking compartment 200a-200g in the drone hotel and the drone is provided. Thus, the connector 210 connects the drone to the docking department. As discussed above, the connector 210 can provide an electrical connection such as a battery recharge or a communication connection such as high-speed internet to download a video or exchange information between the drone and the owner.

When the drone is docked and/or connected to the connector 210 in the docking compartment 200a-200g, a secondary market is created in step 103 between the docked drone and a plurality of drones in the drone hotel. The secondary market can be created by providing an interface showing the owner of the drone the other drones that are currently docked at the drone hotel 200. In this manner, the owners can request to exchange information, goods, etc. using the connector 210 in each compartment of the drone hotel. For example, the secondary market can be created when a safety expert pilots a drone to a city where she has been contracted to evaluate the safety of a new pedestrian mall. The safety expert uses the drone hotel as a base to conduct her evaluation which involves surveillance of public areas during twilight hours. Once her drone is docked and provided a communication connection (e.g., steps 101-102), the safety expert is notified of another drone for police monitoring (e.g., through the secondary market interface). The safety expert can exchange data with the police monitoring drone owner to help the safety expert know of which areas to focus monitoring.

In step 104, a security protocol is provided to an owner of the docked drone. For example, the security protocol can include encrypted and/or passcoded locks on the doors to the compartment, limiting access to the data downloaded from the drone via the communication connection, bullet-proof doors to the compartments, guard drones equipped with defense mechanisms for protecting the drone hotel, etc.

In one exemplary embodiment, the drone hotel 200 may facilitate the use of flying donkeys in Africa. Flying donkeys are cargo drones with rugged air-frames capable of lifting suitcase loads over long distances. The first commercial flying donkeys, due in Africa by 2020, will carry at least 20 kilos over 50 kilometers in less than one hour. The drone hotels can be strategically located along hard to navigate paths in other to optimize charging time and storage in the rough terrain.

Exemplary Aspects, Using a Cloud Computing Environment

Although this detailed description includes an exemplary embodiment of the present invention in a cloud computing environment, it is to be understood that implementation of the teachings recited herein are not limited to such a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail) The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 4, a schematic of an example of a cloud computing node is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring again to FIG. 4, computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external circuits 14 such as a keyboard, a pointing circuit, a display 24, etc.; one or more circuits that enable a user to interact with computer system/server 12; and/or any circuits (e.g., network card, modem, etc.) that enable computer system/server 12 to communicate with one or more other computing circuits. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

Referring now to FIG. 5, illustrative cloud computing environment 50 is depicted. As shown, cloud computing environment 50 comprises one or more cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 5 are intended to be illustrative only and that computing nodes 10 and cloud computing environment 50 can communicate with any type of computerized circuit over any type of network and/or network addressable connection (e.g., using a web browser).

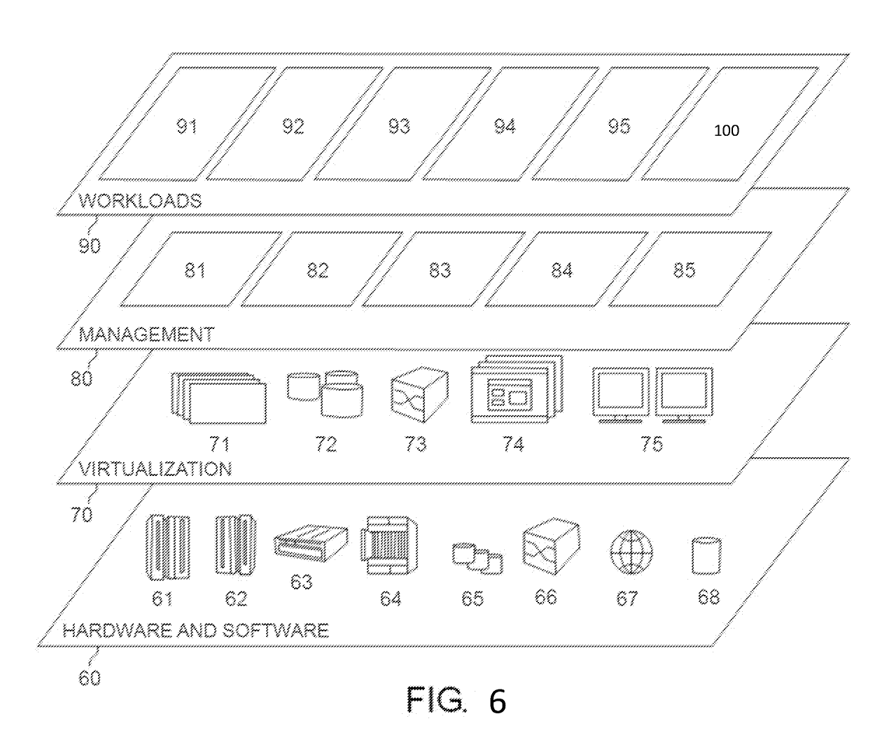

Referring now to FIG. 6, an exemplary set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, more particularly relative to the present invention, the drone hotel control method 100.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A drone hotel, comprising
a plurality of compartments arranged in a docking array for selectively docking at least one drone in a compartment; and
a connector disposed in each compartment for providing a connection to the docked drone of the compartment,
wherein a location of the plurality of compartments in the docking array is based on a function provided by the compartment.

2. The drone hotel of claim 1, further comprising a pole for holding the plurality of compartments around the pole, and
wherein the pole is configured to rotate to provide an optimal positioning for drones with respect to an outside event.

3. The drone hotel of claim 1, wherein the connector of each compartment communicates with each connector to create a secondary market including an interface displaying all of the docked drones and capabilities of the docked drones.

4. The drone hotel of claim 3, wherein the secondary market includes trading, bartering, renting, and auctioning of drones.

5. The drone hotel of claim 3, wherein the interface facilitates requests between owners of different docked drones to share the capabilities of the docked drones.

6. The drone hotel of claim 1, wherein compartments having a same function provided in the compartment are arranged in a same region of the docking array.

7. The drone hotel of claim 1, wherein the function includes:
a type of bandwidth provided in the compartment to the drone;
characteristics of the connector in the compartment;
a Faraday cage;
characteristics of a door to the compartment; and
a temperature control feature of the compartment.

8. The drone hotel of claim 1, further comprising a door for each of the compartments,
wherein the door is configured to open and close based on a security protocol selected by an owner of the docked drone.

9. The drone hotel of claim 1, wherein the connection to the connector provides at least one of a battery recharge, a software update for drone components, and a download feature for drone video and surveillance data.

10. The drone hotel of claim 1, wherein each of the compartments is temperature-controlled to allow for storage of perishable items on the docked drones.

11. The drone hotel of claim 1, wherein the connector includes a mechanical arm to provide stocks of payload materials that support tasks of the docked drone.

12. A computer-implemented drone hotel control method for a drone hotel having a plurality of compartments arranged in a docking array for selectively docking at least one drone in a compartment, the method comprising:
selectively docking a drone in a compartment in the drone hotel;
providing an electrical connection or a communication connection between the compartment in the drone hotel and the docked drone via a connector; and
creating a secondary market between a plurality of drones docked in the drone hotel via an interface displaying each drone connected to the connector of the compartment.

13. The computer-implemented method of claim 12, further comprising providing a security protocol to an owner for the docked drone.

14. The computer-implemented method of claim 12, wherein the docking further provides check-in and check-out services for each drone to register a requested function of the compartment.

15. The computer-implemented method of claim 12, wherein compartments having a same function provided in the compartment are arranged in a same location of the docking array.

16. The computer-implemented method of claim 12, wherein the docking docks drones with similar features in a same compartment or compartments in a same location of the docking array.

17. The computer-implemented method of claim 13, wherein the security protocol comprises providing a security drone equipped with a defense mechanism for protecting the drone hotel.

18. The computer-implemented method of claim 1, embodied in a cloud-computing environment.

19. A drone hotel control system, said system comprising:
a processor; and
a memory, the memory storing instructions to cause the processor to:
selectively docking a drone in a compartment in the drone hotel;
providing an electrical connection or a communication connection between the compartment in the drone hotel and the docked drone via a connector; and
creating a secondary market between a plurality of drones docked in the drone hotel via an interface displaying each drone connected to the connector of the compartment.

20. A computer program product for drone hotel control, the computer program product comprising a computer-readable storage medium having program instructions embodied therewith, the program instructions executable by a computer to cause the computer to perform the method of claim 12.
